(19) United States
(12) Patent Application Publication
(10) Pub. No.: US 2017/0120433 A1
(43) Pub. Date: May 4, 2017

(54) ADAMSWAY HAMMER

(71) Applicant: Adam Satterfield, Franklin Furnace, OH (US)

(72) Inventor: Adam Satterfield, Franklin Furnace, OH (US)

(21) Appl. No.: 14/929,556

(22) Filed: Nov. 2, 2015

(51) Int. Cl. B25D 1/06

(52) U.S. Cl. CPC B25D 1/06

(57) ABSTRACT

A nail holding magnetic hammer that has a handle and a hammer body that coupled to the handle and includes a magnet with first and second ends with the magnetic poles aligned with the central axis is disclosed. The present invention is pre-loaded and is used to start and drive nails without using the other hand to stabilize the nails. This device helps in securing the position of the nail. The head portion of the device is made of heated steel, and the handle is made of wood or metal.

### CROSS REFERENCE TO RELATED APPLICATIONS

Not applicable.

### FEDERALLY SPONSORED RESEARCH & DEVELOPMENT

Not applicable.

### MICROFICHE APPENDIX

Not applicable.

### BACKGROUND OF THE INVENTION

(1) Field of the Invention

The present invention relates to the field of tools, and, more particularly, to a hammer that has a structure for releasably holding a nail in a forward-oriented position to assist in starting said nail.

(2) Background of the Invention

Conventional hammers have existed and been used for many years in homes and for other purposes. Typically, the hammer has a hammerhead that includes a flat face for striking objects, such as nails, tacks, brads, or other similar fasteners. Additionally, hammerheads typically include a body and some form of connection mechanism for mounting the body to a handle. The hammerhead may also include a portion of the body formed into a claw, which may be used, for example, to remove nails from a material in which the nail has been embedded. The typical use of a hammer is for driving objects into another material by aligning the object with the material and striking the object with the flat face such that the object is forcefully driven into the material.

Using a conventional claw hammer to drive nails is tedious because the nail must be held in place with one hand while the hammer is manipulated with the other. Such practice is somewhat dangerous to the worker, as the worker often strikes his or her hand with the hammer while holding the nail in place. Various magnetic hammer heads and magnetic inserts for conventional hammer heads exist in the prior art, and are attempts to alleviate this problem. However, conventional magnetic hammer heads are inconvenient in that the hammer head is continuously magnetized unless the magnet is removed. Usually, magnetization is only required to initially secure the nail to the hammer head for partially driving the nail. Once the nail is partially driven, magnetization is no longer necessary. Accordingly, with conventional magnetized hammers, the hammer head will be magnetically attracted to the nail each time the nail head is struck, thereby hindering the hammering process.

U.S. Pat. No. 2,731,993 suggests a magnetic hammer that has a cylindrical magnetic positioned for insertion within a cylindrical passageway behind the face of the hammering surface.

A lightweight striking tool is described in U.S. Pat. No. 6,435,059 B1 (Martinez, 2002). This prior art invention includes a nail holder groove of magnetic quality for holding a nail for easy setting. This invention differs from the side-load nail holding hammer because the nails that can be retained by the hammer in the prior art are limited in number, size and length, unlike the side-load nail holding hammer for various numbers of nails.

U.S. Pat. No. 5,988,020 (Johnson, 1999) discloses a hammerhead used for magnetically holding nails of different sizes and lengths. This device does not permit the hammer to magnetically attract and retain several nails of different size, length, and width for striking or hammering. In addition, this invention has a U-shaped striking bar, which may have to be replaced in the future.

Therefore, the present novel invention differs from those in the prior art because it permits numerous nails of varying size, length, and width to be placed in the cylindrically shaped slots in the hammer face and back throat, be retained magnetically, and be struck on a surface. Additionally, it includes a hammerhead with a curved claw body. The curved claws enable the removal of nails without damaging the nailed surface. Furthermore, the invention includes an indentation in the neck of the hammer.

### SUMMARY OF THE INVENTION

The present invention constitutes a significant improvement in several aspects over previously identified efforts of the prior art, as described below.

The present invention discloses a magnetic hammer that has a handle and a hammer body that includes a flat face. The magnetic hammer is comprised of a cylindrical magnetic insert that has first and second ends and magnetic poles, which are aligned with the axis of the cylindrical insert for the nails.

The device of this invention includes a pre-loaded manual hammer, which allows the user to drive nails without the use of his second hand/fingers to stabilize the nail.

The device is easy to use, as there is a hollow housing and a magnet. The hollow housing could have multiple hollowed out parts to help drive a large variety of the nails.

Additionally, the device includes multiple housings that could accommodate different dimensions of nails.

As described above, the functional aspects of the present invention is that the device has a magnet for holding the nail. The device has a housing that completely surrounds the nail, to allow for safety and accuracy.

The hammer and magnetic hammer system of an embodiment of the present invention present numerous advantages. It could be used for traditional items, such as driving nails and pulling nails, or simply be used in home-improvement projects. The head of the magnetic hammer device is made of heat treated carbon steel, and the handle could be made of a variety of materials, such as wood, metal, plastic, or fiberglass.

Additionally, due to the magnetic insert being positioned in close proximity to the head portion of the nail, the applicant has found that the nail is sufficiently retained on the hammerhead during the impact of the hammer upon a surface such that even the most difficult nailing applications can be accommodated.

Additional advantages of the invention will be set forth in the description that follows and will be obvious from the description, or they may be learned by practice of the invention. The advantages of the invention may be realized and attained by means of the instrumentalities and combinations that are particularly pointed out in the appended claims. Further benefits and advantages of the embodiments of the invention will become apparent from consideration of the following detailed description with reference to the accompanying drawings, which specify and show preferred embodiments of the present invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is a diagram illustrating the improved magnetic hammer device according to the present invention

### DETAILED DESCRIPTION OF THE INVENTION

The following detailed description refers to the accompanying drawings, which illustrate the embodiments of the present invention. Other embodiments are possible, and modifications may be made to the embodiments without departing from the spirit and scope of the invention. Therefore, the following detailed description is not meant to limit the invention. Rather, the scope of the invention is defined by the appended claims. The FIGURE drawings associated with this disclosure are not drawn with dimensional accuracy to scale, i.e. such drawings have been drafted with a focus on clarity of viewing and understanding, rather than dimensional accuracy.

A hammer is a tool with a heavy metal head that is mounted at right angles at the end of a handle. It is used for jobs such as breaking things and driving in nails. A hammer that may magnetically retain or attract nail(s) of different size, length, and width could also be used as an easy and secure way of holding the nail in place.

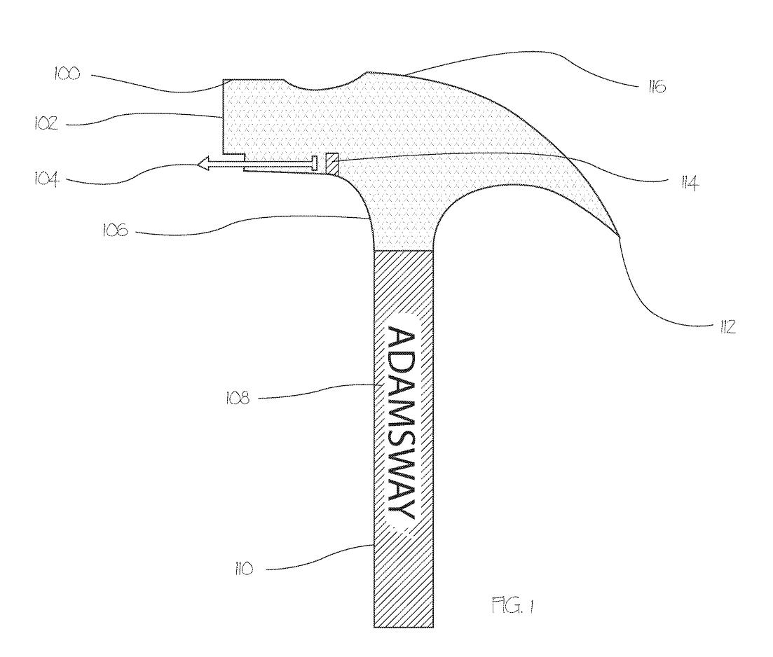

As shown in FIG. 1, a nail holding hammer system 100 that includes a cylindrical nail holder 104 is provided. As shown in FIG. 1, the nail holding hammer system 100 is comprised of a hammer head 102 that includes a striking surface, a shaft 108, and a handle 110. Furthermore, the nail holding hammer system 100 may be approximately configured and may function substantially similarly to a carpenter's hammer. More specifically, the nail holding hammer system 100 may be approximately configured as and may function substantially similarly to a carpenter's claw hammer. For example, a user may grasp the hammer system on handle 110 to swing the hammer head 102 coupled to and/or integrally formed with the shaft 108 to strike and drive a nail with the striking surface. Errant nails may be removed by prying the nails with the nail remover 112, which may be approximately configured as and may function substantially similarly to a hammer claw. In another aspect, the hammer head 102 that includes a striking surface and the nail remover 112 may be integrally formed.

Simply stated, the nail holding hammer system 100 of an embodiment may allow a user to start driving a nail (e.g., into a wall or the like) without having to hold the nail with their other, non-hammering hand. For example, the hammer system 100 may accept and detachably couple to a nail. Furthermore, described with reference to the cylindrical magnet holder 114 that detachably engages a nail, the nail holding hammer system 100 may include alternate detachable engagement means to hold the nail in place for its initial strike.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I claim:

1. A nail holding magnetic hammer comprising:
a handle,
a hammer head mounted onto the handle and that has a generally flat hammer face,
a cylindrical magnetic holding portion formed into the hammer body; and
a nail holding portion formed into the hammer body.

2. The nail holding magnetic hammer according to claim 1, wherein said handle is made by heated steel.

3. The nail holding magnetic hammer according to claim 1, wherein a synthetic grip covers the handle.

4. The nail holding magnetic hammer according to claim 1, wherein said hammer head mounted on the handle is made of wood or metal.

5. The nail holding magnetic hammer according to claim 1, wherein said magnet is centered in said hammer head.

6. The nail holding magnetic hammer according to claim 1, wherein said cylindrical magnet holder mechanically retains a magnet insert.

7. The nail holding magnetic hammer according to claim 1, wherein the magnet insert is comprised of a conventional natural magnet that is obtainable through building supply retailers.

8. The nail holding magnetic hammer according to claim 1, wherein the weight of said nail holding magnetic hammer is 16-28 oz.

9. The nail holding magnetic hammer according to claim 1, wherein the length of said nail holding magnetic hammer is 14-18 inches.

10. The nail holding magnetic hammer according to claim 1, wherein the nail is substantially centered on said hammer head.
